(19) United States
(12) Patent Application Publication
(10) Pub. No.: US 2009/0244919 A1
(43) Pub. Date: Oct. 1, 2009

(54) Vehicle head lamp provided with dimming screen

(76) Inventor: Rodolfo Sirolla, Passo Varano Ancona (IT)

Correspondence Address: HODES, PESSIN & KATZ, P.A., 901 Dulaney Valley Road, Suite 400, Towson, MD, 21204, US

(21) Appl. No.: 12/309,236

(22) PCT Filed: Sep. 14, 2007
(86) PCT No.: PCT/IT2007/000638

§ 371 Date: Jan. 9, 2009

(30) Foreign Application Priority Data
Sep. 20, 2006 (IT) MC2006A000125

(51) Int. Cl. F21V 17/02

(52) U.S. Cl. 362/512

(57) ABSTRACT

The present invention relates to a vehicle head lamp (1) characterised by the fact that it is internally provided with a lamp (2) and a screen (7) in opposite position, which is designed to partially dim the light beam, by alternatively rotating from an operating position to a non-operating position, being joined to the shaft (6) of a solenoid (5) with predefined rotation angle that can be actuated by the driver.

The present patent application relates to a head lamp for cars and motorcycles provided with a partial dimming screen.

As it is known, all vehicles use head lamps with different power.

In fact, in addition to the so-called side lamps, motor vehicles must be provided with passing beam and high beam lamps, designed to be alternatively used according to the different traffic and visibility conditions.

So far, this need has been satisfied by using two different lamps inside the same head lamp: one lamp with lower power as passing beam and one lamp with higher power as high beam.

Of course, the use of two different lamps in the same head lamp involves a considerable cost increase and a significant complication for the vehicle electrical system.

The head lamp of the invention has been devised to overcome these two inconveniences. For the first time, the head lamp of the invention can generate light beams with different power, although it uses one lamp only (of course, in addition to the lamp for the so-called side lamps).

This result has been achieved by installing a high-power lamp in the head lamp (of the type normally used to generate high beam) and provide it with a screen that partially dims the light beam.

In view of the above, the lamp used in the head lamp of the invention can generate a traditional passing beam when the screen is maintained in operating position to partially dim the light from the lamp.

The same lamp can generate a high beam when the user controls the screen in such a way as to remove the partial interference with the light beam generated by the lamp.

The position of the screen is controlled by the driver by means of controls that are similar to the ones normally used to alternatively select one of the two lamps of traditional head lamps, also for what refers to the reaction time to the control given by the user.

The need to ensure that the position of the screen can be changed in a very short time has required to overcome an important technical problem, since the known technology did not offer a suitable actuator.

This specific technical problem has been overcome by designing a special solenoid with predefined rotation angle, which—once it has been electrically energised—can impose a sudden rotation to the screen, thus instantaneously switching the light of the associated lamp from passing to high beam.

Moreover, the solenoid is internally provided with an elastic return element designed to bring the screen back immediately to the partial interference position, thus restoring the passing beam, once the electrical energisation has ended.

For major clarity the description of the invention continues with reference to the enclosed drawing, which only has an illustrative, not limiting value, whereby:

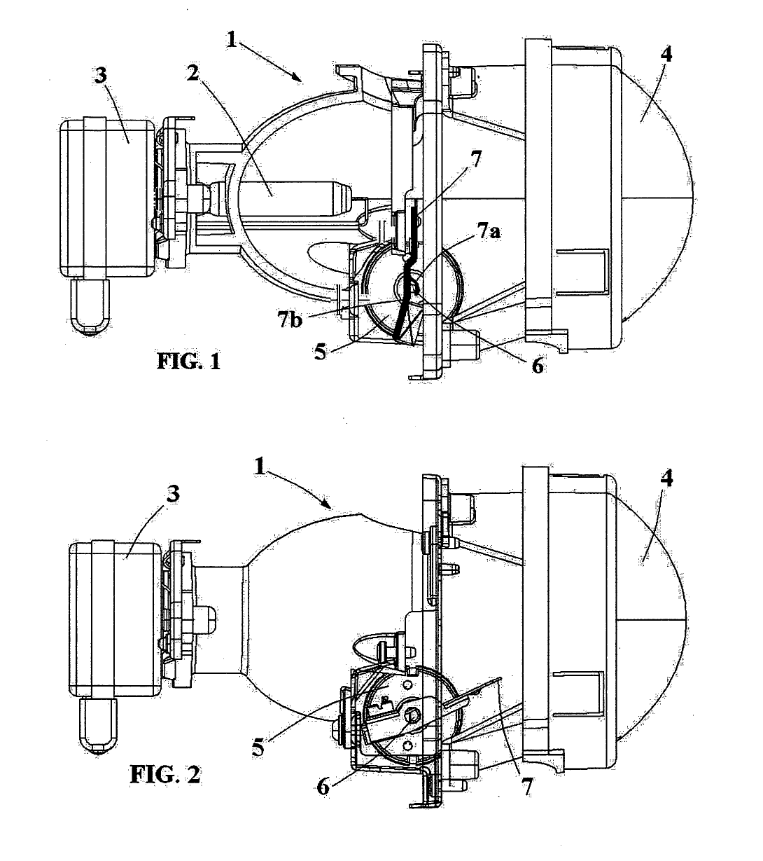

FIG. 1 is a diagrammatic side view of the head lamp of the invention, with the screen in operating position;

FIG. 2 is the same as FIG. 1, with the screen in non-operating position;

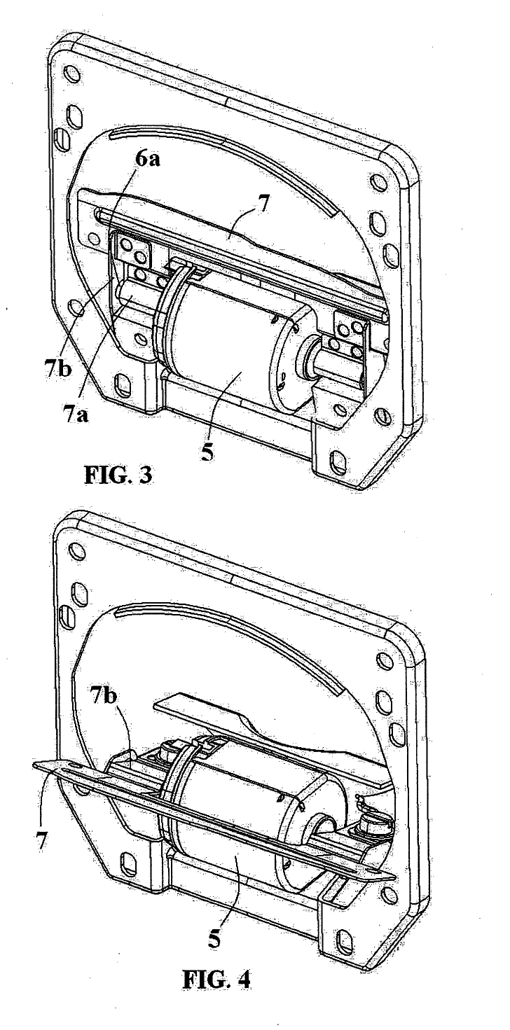

FIG. 3 is a diagrammatic front view of the head lamp of the invention, with the screen in operating position;

FIG. 4 is the same as the preceding figure, with the screen in non-operating position;

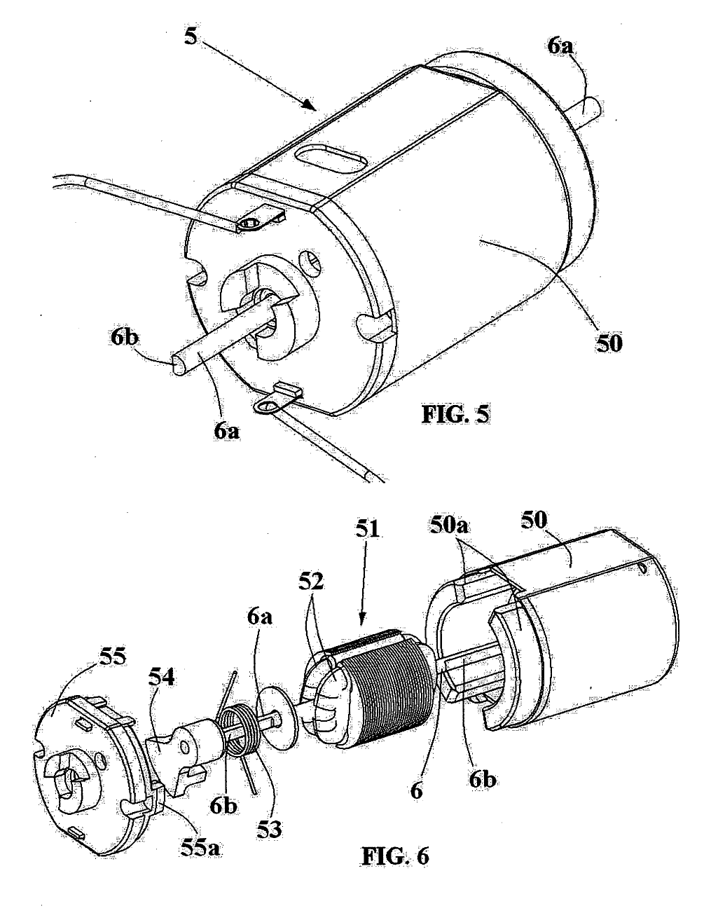

FIG. 5 is an axonometric view of the special solenoid used in the head lamp of the invention;

FIG. 6 is an exploded drawing of the solenoid shown in the preceding figure;

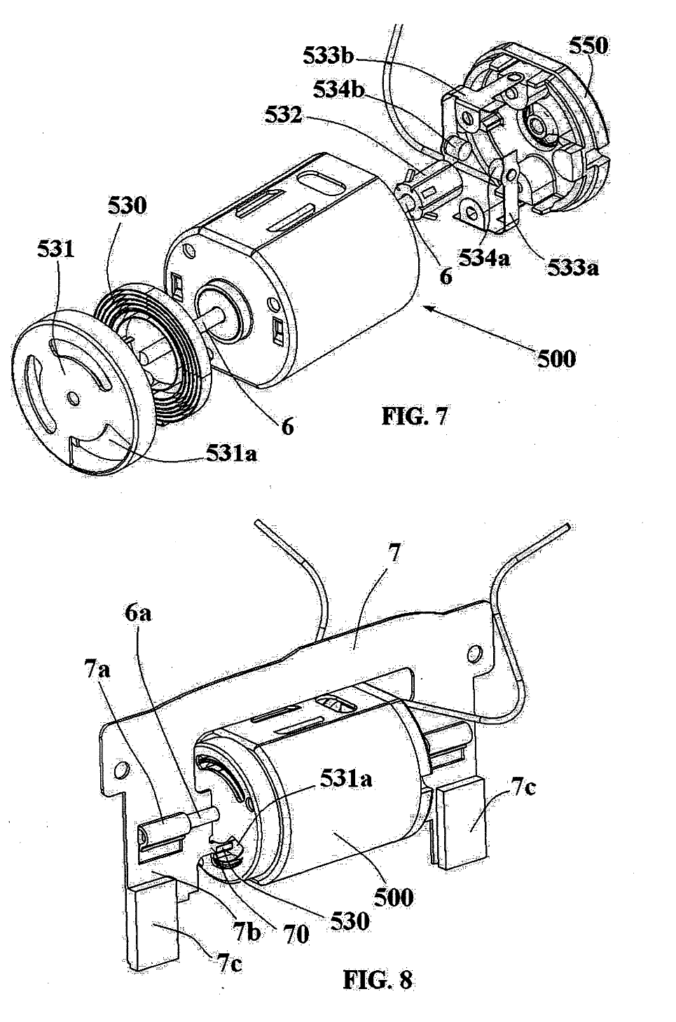

FIG. 7 and FIG. 8 show an alternative constructive version of the solenoid.

With reference to FIGS. 1 and 2, the head lamp of the invention (1) employs a single lamp (2) with power similar to traditional high beam lamps, which is connected to a traditional support and power supply unit (3) and is protected by an ordinary transparent front glass (4).

A special rotary solenoid (5) with predefined rotation angle (see FIGS. 5 and 6) is horizontally mounted right below the aforementioned support and power supply unit (3) of the lamp (2), with the shaft (6) that projects with the ends (6a) on the two sides of the cover (50) of the solenoid (5).

The ends (6a) are joined with corresponding tubular housings (7a) obtained on the two wings (7b) that protrude from a C-shaped screen (7), as shown in FIGS. 3 and 4; it being provided that the distance between the two wings (7b) of the screen (7) is slightly longer than the length of the solenoid (5).

It must be noted that the ends (6a) of the shaft (6) of the solenoid (5) are provided with a faceted finish (6b) that prevents mutual sliding between each end (6a) and the corresponding housing (7a).

The screen (7) is designed to normally maintain a basically vertical edgeways position (as shown in FIGS. 1 and 3), in which it partially interferes with the light beam generated by the lamp (2); as shown in FIG. 1, the said interference is generated on the lower section of the light beam.

The solenoid (5) is connected with the control traditionally provided to the vehicle's driver to activate or deactivate the high beam.

The activation of the control by the driver causes the immediate removal of the screen (7), thus eliminating the partial interference with the light beam.

More precisely, the actuation of the high beam control immediately determines the following sequence, i.e. the electrical energisation of the solenoid (5), the rotation of the shaft (6) and the downward forward turning over of the screen (7) joined to it (until the specific position shown in FIGS. 2 and 4 is reached).

A similar rotation allows the screen (7) to remove the partial interference that was caused on the lower part of the luminous beam and allows the lamp to generate a high beam.

Vice versa, the interruption of the high beam activation control electrically de-energises the solenoid (5), in such a way that the shaft (6)—suitably subjected to the action of a return spring—makes an inverse rotation, which corresponds to the upward backward turning over of the screen (7), thus allowing the screen (7) to restore the partial interference with the lower part of the light beam generated by the lamp (2).

This description continues with a detailed description of the structure of the solenoid (5), because—as mentioned earlier—it is the result of a specific innovative design, and not a traditional solenoid.

With reference to FIG. 6, the solenoid of the invention (5) is provided with a cover-stator (50) with two magnetised elements (50a), i.e. N pole (north) and S pole (south).

The cylindrical cover (50) houses, suitably inserted in the shaft (6), a rotor (51) composed of sheet metal with electrical insulation, a two-part coil (52) made of high-temperature copper wire, a suitably loaded return spring (53) and a spring-holder sector (54); it being provided that the cover (50) is closed by a head (55) that is internally provided with two mechanical stops (55a) that determine the ends of the predefined rotation angle imposed to the shaft (6).

To better understand the operation of the solenoid (5) shown in FIG. 6, it must be noted that, upon the activation of the high beam control, the coil (52) is passed by a current that generates the two magnetic poles in the rotor (51), which consequently interact with the stator magnetic field generated by the magnets (50a) incorporated in the cover (50).

This generates a torque that determines the rotation of the shaft (6) and the screen (7) joined to it, until a suitable stop.

To that end, it must be noted that if the solenoid (5) makes an uncontrolled rotation, it will be brought in a position in which the orientation of the magnetic field is parallel to the magnetic field generated by the magnets (50a) incorporated in the cover (50); moreover, if this position is reached, the additional passage of current will not permit any rotation of the solenoid (5).

In order to avoid such a negative phenomenon, the orientation of the rotor (51) in the magnetic field has been optimised in such a way to maximise the torque generated by the current inside the solenoid (5).

To that end, in view of the position between the mechanical stops (55a) of the head (55), the spring-holder sector (54) joined to the shaft (6) is designed to make the solenoid (5) rotate only by the requested angle that coincides with the angular distance between the two mechanical stops (55a).

As soon as the solenoid (5) is no longer powered, the antagonist spring (53) brings the shaft (6) and the rotor (51) associated with it to the initial position, which corresponds to the interference of the screen (7) with the light beam generated by the lamp (2).

It must be noted that the spring (53) is anchored inside the solenoid (5) to a fixed point inside the head (55) on one side, and to the circular sector (54) on the other side.

Obviously, the antagonist spring (53) must generate a suitable torque to ensure a rotation of the shaft (6) that can bring the screen (7) back to the original position.

In particular, the spring (53) is able to achieve this function due to the suitable preload value inside the solenoid (5); moreover, the preload avoids undesired movements of the screen (7) possibly caused by the vibrations generated by the vehicle motion or, more generally, by the surrounding operating environment.

Moreover, the antagonist torque created by the preloaded spring (53) does not need to prevent the rotary solenoid (5) from travelling the entire angle required to open and close the screen (7) at the temperatures and applied voltages, including in the most severe operating conditions.

Finally, it must be noted that, with special reference to the structure of the solenoid, the present inventive idea could also be implemented according to alternative constructive solutions that are functionally equal.

For instance, the solenoid can have a non-cylindrical cover for a better housing of the structure of the head lamp of the invention.

Moreover, the shaft of the solenoid can have only one end that protrudes from the cover of the solenoid; in this case, the matching between shaft and screen is only realised on one side of the solenoid.

Likewise, the antagonist spring can have a different size and shape and can be situated in external position of the cover, together with the stops.

With special reference to FIGS. 7 and 8, the external spring (530) is of spiral type and one of the ends is engaged in a fixed point inside a suitable spring-holder disk (531) inserted in the shaft (6) of the solenoid, and the other end is engaged in a mobile point consisting in a small appendix (70) that horizontally protrudes from one of the wings (7b) of the screen (7).

The spring-holder disk (531) is provided with a large window (531a) that houses the horizontal appendix (70) of the spring (7b), in such a way that it favours the engagement with the corresponding end of the spring (530).

The borders of the window (531a) act as stops for the inverse rotations of the shaft (6) of the solenoid (500).

In this specific constructive version, the solenoid (500) has a different internal configuration.

In this case, it is provided with a “DC-type” collector (532) on the shaft (6) and with two flexible brackets (533a, 533b) with charcoals (534a, 534b) that cooperate with the collector (532), being fixed on the inside of the cover (550).

The flexible brackets (534a, 534b) also comprise corresponding tongues designed to pass through suitable holes obtained on the head (550) in order to permit the connection on the outside with the electrical cables.

The power to the winding (not shown in the enclosed figures) is given by means of the rotating contact between the charcoals (534a, 534b) and the collector (532).

Finally, FIG. 7 shows the application of two small weights (7c) on the lower section of the wings (7b) of the screen (7) situated below the insertion point of the corresponding end (6a) of the shaft (6) of the solenoid (5).

In this way, the weights (7c) are designed to bring the screen (7) back to its operating position, in which it interferes by gravity with the light beam generated by the lamp (2) in case of breakage (or absence) of the antagonist spring.

1. Vehicle head lamp characterised by the fact that it is internally provided with a lamp (2) and a screen (7) in opposite position, which is designed to partially dim the light beam by alternatively rotating from an operating position to a non-operating position, being joined to the shaft (6) of a solenoid (5, 500) with predefined rotation angle that can be actuated by the driver by means of a specific control.

2. Head lamp as claimed in claim 1, characterised by the fact that the solenoid (5, 500) is horizontally and transversally mounted right below the support and power supply unit (3) of the lamp (2), in such a way that the rotary screen (7) joined to it can pass from a basically vertical position, in which it interferes with the lower section of the luminous beam of the lamp (2), to a forward position, in which the said interference is completely eliminated.

3. Head lamp as claimed in claim 1, characterised by the fact that the rotary screen (7) has a C-shape and is provided with two wings (7b) with corresponding tubular housings (7a) designed to receive and hold the ends (6a) of the shaft (6) of the solenoid (5, 500) that protrude from opposite sides from a cover (50) of the solenoid (5, 500).

4. Head lamp as claimed in claim 1, characterised by the fact that the rotary screen (7) is provided with a single lateral wing designed to be joined with an end of the shaft (6) of the solenoid (5, 500) that protrudes from a cover of the solenoid (5, 500).

5. Head lamp as claimed in claim 3, characterised by the fact that the protruding ends of the shaft (6) of the solenoid (5, 500) have a faceted finish (6b).

6. Head lamp as claimed in claim 3, characterised by the fact that the screen (7) has a small weight (7c) on the lower section of each wing (7b) situated below the insertion point of the corresponding end (6a) of the shaft (6) of the solenoid (5).

7. Head lamp according to claim 1, characterised by the fact that the solenoid (5) is provided with a cover-stator (50) with magnetised elements (50a) that houses the following parts, suitably inserted in the shaft (6), that is to say a rotor (51) composed of sheet metals with electrical insulation, a two-part coil (52) made of high-temperature copper wire, a preloaded return spring (53), a spring-holder sector (54) designed to interfere, following to opposite rotations of the shaft (6), with two mechanical stops (55a) internally provided in the head (55) that closes the cover (50).

8. Head lamp as claimed in claim 7, characterised by the fact that the solenoid (500) is internally provided with a “DC type” collector (532) inserted on the shaft (6), two springs (533a, 533b) internally fixed to the cover (550) to support relevant charcoals (534a, 534b) designed to realise a rotary contact with the collector (532); it being provided that the solenoid (500) has an external spiral spring (530) on the opposite side with respect to the cover (550), which is engaged at one end in a fixed point inside a suitable spring-holder disk (531 ) and at the other end in a mobile point consisting in a small appendix (70) that horizontally protrudes from one of the wings (7b) of the screen (7) and is engaged inside a large curvilinear window (531a) obtained on the said spring-holder disk (531), whose borders act as stops for the inverse revolutions of the shaft (6) of the solenoid (500).
